(19) United States
(12) Patent Application Publication
(10) Pub. No.: US 2021/0141706 A1
(43) Pub. Date: May 13, 2021

(54) SANITIZATION LOGGING BASED ON USER TOUCH LOCATION

(71) Applicant: Hewlett-Packard Development Company, L.P., Spring, TX (US)

(72) Inventors: John Frederick, Spring, TX (US); Dave Nypaver, Spring, TX (US); Tim Guynes, Spring, TX (US); Syed S. Azam, Spring, TX (US)

(73) Assignee: Hewlett-Packard Development Company, L.P., Spring, TX (US)

(21) Appl. No.: 17/043,819

(22) PCT Filed: Jul. 31, 2018
(86) PCT No.: PCT/US2018/044709

§ 371 Date: Sep. 30, 2020

(51) Int. Cl. G06F 11/34; G06F 11/32; G06F 3/0488; G06F 9/451

(52) U.S. Cl. CPC G06F 11/3438; G06F 9/451; G06F 3/0488; G06F 11/32

(57) ABSTRACT

In an example implementation according to aspects of the present disclosure, a method may receive an indication of a user touch upon a display. Upon the touch, a record of the touch and location of the touch is created. A request to sanitize the surface of the display is received. The record is recalled, responsive to the request and the display presents an indication on the display in the location of the user touch, where the display is to be sanitized.

### BACKGROUND

In public areas, people interface with touchscreen displays. Often the interfacing includes touching menu items to extract information from the device. Over the course of a day, many people touch the displays as well as the housings the displays and associated computing components.

### BRIEF DESCRIPTION OF THE DRAWINGS

FIGS. 1A, 1B, 1C illustrate states of a display undergoing logging of sanitization events, according to an example;

FIGS. 2A, 2B, 2C illustrate states of a display utilizing an onscreen display to log sanitizing events according to an example;

FIG. 3 is a diagram illustrating a distributed system for the logging of display sanitizing events, according to an example;

FIG. 4 is a flow diagram illustrating a method of logging sanitization events for a display, according to an example;

FIG. 5 is a block diagram illustrating a computing device to log sanitization events for a display in accordance with an example of the present disclosure.

FIG. 6 is a block diagram illustrating a system 600 to log sanitization events in accordance with an example of the present disclosure

### DETAILED DESCRIPTION

Examples disclosed herein describe a display system with a logging module to detect user touches on a display. A user touch may include any interface with a display that may result in the requirement of sanitization. User touches may include physical touches by direct human interaction with a touchscreen interface or the housing for the entire unit. Additionally, user touches may include other events that may require sanitization including coughs and sneezes. The display system with logging module creates a record of the user touch including a time, date and location of the user touch. The display system with a logging module may receive a request for sanitization of the display. The request may be received from an onscreen display dialogue, a pre-set timer, a usage-based timer, or a networked notification request from a sanitization control server. The display system with logging module may recall the location of the user touch and display a notification on the screen showing where the display needs to be sanitized.

FIGS. 1A, 1B, 1C illustrate states of a display undergoing logging of sanitization events, according to an example. In reference to FIGS. 1A, 1B, 1C, the display 100A, 100B, 100C may be operating in various states. Common to the display 100A, 100B, 100C may include a housing 102 and a screen 104. The housing 102 may include a bezel as well as the outer enclosure of the display. The housing 102 may protect the interior components from exposure as well as to provide an aesthetic detail to the display. The housing 102 may be constructed of plastics or metallic materials. Additionally, the housing 102 may include capacitive digital skin capable of detecting input from a user touch and provide a mapping between the surface of the digital skin and the point of the user's touch. The housing 102 may include associated components integrating the display 100A, 100B, 100C into another device. For example, the housing 102 may also include the outer encasings of other devices that utilize a display 100A, 100B, 100C including but not limited to printers, laptop computers, kiosks, point-of-sale terminals, and medical equipment.

The screen 104 may include a touchscreen device. The touchscreen may include a digitizer to receive input from a user. The screen 104 may be implemented as but not limited to capacitive and resistive touchscreens. The screen 104 may be multi-point touch capable, in that they can received multiple inputs simultaneously. Additionally, the screen 104 may include circuitry to turn the touch into an indication within the defined space of the touchscreen. In one example, the indication may correspond to an cartesian coordinate value-pair. The cartesian coordinate value-pair may contain an X-axis value and a Y-axis value corresponding to the point of touch on the screen.

Display 100A illustrates the display interfacing with a user. The user provides an input 106 to the display 100A at a location on the display. The display 100A may receive that user input as a cartesian coordinate value pair corresponding to the location touched on the display. The user input may be stored as the cartesian coordinate value pair as well as a time and date corresponding to the time that the display 100A was touched. The display 100A logs every touch to the display 100A, including touch to the screen 104 and the housing 102. Every touch recorded to the display 100A, may be stored in memory by a logging module. The storage in memory may include the usage of database or flat file. The storage may take place in random access memory (RAM), or alternatively in non-volatile memory(NVM) to allow the recall of touch records in the event of power interruption.

Referencing FIG. 1B, the display 100B has received a request for sanitization. The request may be received by the logging module. The request may be generated by a predefined timer, a usage-based event, a network request, and an onscreen display dialogue. A predefined timer may include an instance where the logging module schedules a sanitization event at a specific time on a specific day. Additionally, predefined timers may include recurrent timers such as executing a sanitization cycle at the same time on the same day of the week. A usage-based event may include the logging module detecting a certain number of user touches in a close proximity on the Display 100B. In the event that the user touches take place within a given timeframe, the logging module may schedule a sanitization cycle based on the number of touches within the timeframe. In the usage-based event example the request to sanitize the surface may be generated based on a number of records passing a threshold. The records correspond to user touches in the same or close location. A network request may be received by the logging module across a network. The network may be implemented as but is not limited to a local area network (LAN) or wide area network (WAN). The network request may come from a sanitization control server responsible for the sanitization of more than one display 100B. A request from an onscreen display (OSD) dialogue may be received by the logging module. The OSD dialogue may be user initiated. The OSD dialogue may be instantiated by a button push on the housing or alternatively on a remote-control command.

Upon receiving the request for sanitization, the display 100B may provide an indication of a surface to be sanitized 110. The surface to be sanitized 110 may correspond to a set of user touches recalled by the logging module. The indication of the surface to be sanitized 110 may be displayed on the screen 104 demonstrating a portion of the screen that corresponds to the records recalled by the logging module. Additionally, an OSD notification 108 may be instantiated to provide more guidance to the area of the screen 104 to be sanitized. The OSD notification 108 may also provide instruction or direction for sanitizing portions of the display 100B that do not relate to the screen 104. The OSD notification 108 may provide instruction for the sanitization of the housing 102, wherein any touches to the housing are logged through capacitive digital skin.

During the sanitization process, whether by automated systems or manual systems, the logging module logs the process. Through the sanitization process, the logging module receives more touches corresponding to sanitizing mechanisms coming into contact with the surface of the screen 104 and the housing 102. The logging module determines based at least in part on the number of user touches in a location how many sanitization touches are necessary sanitize the surface to be sanitized 110.

Referencing FIG. 1C, upon completion of the sanitization sequence, an OSD notification 112 may present a message indicating that the sanitization cycle is complete. Alternatively, the OSD notification 112 may present a message indicating that the sanitization cycle is incomplete.

FIGS. 2A, 2B, 2C illustrate states of a display utilizing an OSD to log sanitizing events according to an example. In one example, a request for sanitization may be received by the logging module as a function of an OSD dialogue. The OSD dialogue may be operated by a button array on the display or by remote control.

In one example, referring to FIG. 2A, an onscreen menu display 202 may be invoked utilizing the controls of the display 200A. The onscreen menu display 202 may include options allowing a user to adjust attributes of the screen, or configure input/output devices such as network connections.

Referring to FIG. 2B, an onscreen menu display option 204 may be presented as an option to the onscreen menu display 202. The onscreen menu display option 204 may present an option for a sanitization cycle.

Referring to FIG. 2C, an onscreen menu display selection 206 may result from the selection of the onscreen menu display option 204. The onscreen menu display selection 206 presents a selection to start a sanitization cycle from the OSD. Upon selecting the onscreen menu display selection 206, the OSD propagates a request, received by the logging module, to begin the sanitization cycle.

FIG. 3 is a diagram illustrating a cloud-based sanitization tracking system 300 for the logging of display sanitizing events, according to an example. The cloud-based sanitization tracking system 300 may be utilized for the control and sanitization of multiple displays. The cloud-based sanitization tracking system 300 may be integrated without automated sanitization systems to create a comprehensive standards compliant sanitization system.

As described in reference to FIGS. 1A, 1B, 1C, the display utilizes a housing 102 and a screen 104 capable of detecting a user touch 106. In the cloud-based sanitization tracking system 300, the user touch 106 may be logged to a logging module within the display. Alternatively, the logging module may execute on the sanitization server 304, and the display may relay the user touch 106 to the logging module. In another example, the logging module may execute on the display and propagate the user touch indications to the sanitization server 304 for redundancy and system robustness.

A network 302 facilitates the transmission of user touches to the sanitization server 304 and requests to for sanitization to the display. The network 302 may be a local area network (LAN), a wide area network (WAN), or the internet. The network 302 may be implemented in any suitable lower level layers of the Open Systems Interconnection (OSI) network stack capable of supporting application layer functionality for the transmission and receipt of user touch 106 data and sanitization request messages.

The sanitization server 304 may be a computer or a system of computers for the control and verification of sanitization. The sanitization server 304 may execute the logging module remotely from the display, connected to the display through the network 302. The sanitization server 304 may operate on a physical computer dedicated for the purpose of interfacing with displays. Alternatively, the sanitization server 304 may be a logical or virtual computer. The sanitization server 304 host additional software for the sanitization of the display that may be configured to send requests for sanitization over the network. Upon the successful completion of a sanitization cycle, the logging module further configured to send the sanitation record to a cloud-based sanitization tracking system.

FIG. 4 is a flow diagram illustrating a method of logging sanitization events for a display, according to an example.

At step 402, the logging module receives a first indication of a user touch on a display. A user touch includes a touch to a display. The touch may be an interaction with a touchscreen display, or a touch to a non-interactive component of the display including the housing of the display. The indication may include location information corresponding to the point of the display that the user touch took place.

At step 404, the logging module creates a record of the user touch indication. The user touch indication. The record may include an entry in a memory location of RAM or NVM corresponding to the user touch and includes a time, date, and location of the user touch. In other examples, the record may be stored in disk-based storage device including but not limited to hard disk drives, solid state disk drives, flash memory, disk arrays and databases.

At step 406, the logging module receives a request to sanitize a surface of the display The logging module parses the request to sanitize the surface of the display. The request may include a requestor and an address to respond to the requestor if the requestor is not a local requestor. The request may also include a time and date stamp for synchronization between a non-local requestor and the display.

At step 408, the logging module recalls, responsive to the request, the record. The logging module may query the records for user touches. The querying may include database lookups, or the processing of memory data structures dependent upon implementation. The logging module may organize user touches into designated location areas corresponding to the display based on where the user touch locations. The logging module may aggregate the number of user touch locations to the designated locations. In one example, designated locations may include the logical portioning of the screen surface into subareas.

At step 410, the logging module sends a second indication to the display near the location on the display of the first indication. The logging module may interface with a video frame buffer to send the second indication. The second indication corresponds with a demarcation where sanitization may occur. The second indication may be displayed as a color-coded indication on the display. The color-coded areas may represent varying degrees of needed sanitization and displayed as contour mapping. The color-coded indication may correspond to an intensity of necessary sanitization based on the number of records including that location. Alternatively, the display may place markers on the display indicating where each individualized user touch indication occurred.

Additionally, the display receives, a third indication of sanitization on the display. The third indication corresponds with a sanitization touch which occurs when the display has been sanitized. The third indication may correspond to the location on the display corresponding to the second indication. Upon receipt of the third indication, a sanitation record of the third indication is created corresponding to a time and date that the third indication was received.

FIG. 5 is a block diagram illustrating a computing device to log sanitization events for a display in accordance with an example of the present disclosure.

The computing device 500 depicts a processor 504 and a memory device 506 and, as an example of the computing device 500 performing its operations, the memory device 506 may include a logging module 508 and instructions 510-518 that are executable by the processor 504. Thus, memory device 506 can be said to store program instructions that, when executed by processor 504, implement the components of the computing device 500.

Memory device 506 represents generally any number of memory components capable of storing instructions that can be executed by processor 504. Memory device 506 is non-transitory in the sense that it does not encompass a transitory signal but instead is made up of at least one memory component configured to store the relevant instructions. As a result, the memory device 506 may be a non-transitory computer-readable storage medium. Memory device 506 may be implemented in a single device or distributed across devices. Likewise, processor 504 represents any number of processors capable of executing instructions stored by memory device 506. Processor 504 may be integrated in a single device or distributed across devices. Further, memory device 506 may be fully or partially integrated in the same device as processor 504, or it may be separate but accessible to that device and processor 504.

In one example, the logging module 508 and the program instructions 510-518 can be part of an installation package that when installed can be executed by processor 504 to implement the components of the computing device 500. In this case, memory device 506 may be a portable medium such as a CD, DVD, or flash drive or a memory maintained by a server from which the installation package can be downloaded and installed. In another example, the program instructions may be part of an application or applications already installed. Here, memory device 506 can include integrated memory such as a hard drive, solid state drive, or the like.

FIG. 6 is a block diagram illustrating a system 600 to log sanitization events in accordance with an example of the present disclosure. The system 600 may include a display 100, a processor 602, and a logging module 508. The display 100 may correspond to previously described display 100A, 100B, 100C. A processor 602 may interface with the display 100 through a wired or wireless connection. The processor 602 may receive user touch data through the wired or wireless connection. A logging module 508 may execute on the processor 602. The logging module 508 may be stored in a memory device 506. Additionally, as described above, the logging module 508 may execute instructions corresponding to the instructions 510-518.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in me art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a display;
a processor communicatively coupled to the display; and
a logging module configured to execute on the processor to:
receive a first indication of a user touch on the display; wherein the first indication comprises a location on the display;
create a record of the first indication wherein the record corresponds to a time, date, and location that the first indication was received;
receive a request to sanitize a surface of the display;
recall, responsive to the request, the record; and
send a second indication to the display; wherein the second indication indicates the location from the record on the display and the second indication corresponds to a position on the display to be sanitized.

2. The system of claim 1, the logging module further configured to:
receive, responsive to displaying the second indication, a third indication of sanitization on the display; wherein the third indication of sanitization comprises a location on the display corresponding to the second indication; and
create a sanitation record of the third indication wherein the sanitation record corresponds to a time and date that the third indication was received.

3. The system of claim 2, the logging module further configured to send the sanitation record to a cloud-based sanitization tracking system.

4. The system of claim 3, wherein the request to sanitize the surface of the display is received from the cloud-based sanitization system.

5. The system of claim 1, wherein the request to sanitize the surface is generated by a timer.

6. The system of claim 1, wherein the request to sanitize the surface is generated based on a number of records passing a threshold; wherein the number of records correspond to user touches in a location.

7. A computing device comprising:
a memory device having instructions stored thereon and
a processor configured to perform, when executing the instructions to:
receive a first indication of a user touch on a display; wherein the first indication comprises a location on the display;
create a record of the first indication wherein the record corresponds to a time, date, and location that the first indication was received;
receive a request to sanitize a surface of the display;
recall, responsive to the request, the record; and
send a second indication to the display; wherein the second indication indicates the location from the record on the display, the second indication corresponds to a position on the display to be sanitized, and the second indication indicates an intensity corresponding to a number of records corresponding to the location.

8. The computing device of claim 7, further comprising instructions to:
receive, responsive to displaying the second indication, a third indication of sanitization on the display; wherein the third indication of sanitization comprises a location on the display corresponding to the second indication; and
create a sanitation record of the third indication wherein the sanitation record corresponds to a time and date that the third indication was received.

9. The computing device of claim 8, further comprising instructions to send the sanitation record to a cloud-based sanitization tracking system.

10. The computing device of claim 9, wherein the request to sanitize the surface of the display is received from the cloud-based sanitization system.

11. The computing device of claim 7, wherein the request to sanitize the surface is generated by a timer.

12. The computing device of claim 7, wherein the request to sanitize the surface is generated based on a number of records passing a threshold; wherein the number of records correspond to user touches in a location.

13. A method comprising:
receiving a first indication of a user touch on a display, wherein the first indication comprises a location on the display and the display comprises display panel, a touchscreen and a housing;
creating a record of the first indication wherein the record corresponds to a time, date, and location that the first indication was received;
receiving a request to sanitize a surface of the display; wherein the request to sanitize the surface is generated based on a number of records passing a threshold and the number of records correspond to user touches in a location;
recalling, responsive to the request, the record; and
sending a second indication to the display; wherein the second indication indicates the location from the record on the display and the second indication corresponds to a position on the display to be sanitized.

14. The method of claim 13, further comprising;
receiving, responsive to displaying the second indication, a third indication of sanitization on the display; wherein the third indication of sanitization comprises a location on the display corresponding to the second indication; and
creating a sanitation record of the third indication wherein the sanitation record corresponds to a time and date that the third indication was received.

15. The method of claim 14 further comprising sending the sanitation record to a cloud-based sanitization tracking system.
